(19) United States
(12) Patent Application Publication
(10) Pub. No.: US 2006/0037716 A1
(43) Pub. Date: Feb. 23, 2006

(54) Roller screen for retractable doors

(76) Inventor: Paul Robert Hatten, Bongaree (AU)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/204,274

(22) Filed: Aug. 15, 2005

(30) Foreign Application Priority Data
Aug. 20, 2004 (AU) 2004100687

(51) Int. Cl. E06B 3/48

(52) U.S. Cl. 160/113

(57) ABSTRACT

A roller screen is retrofitted to the lower edge of a retractable door, which screen is the same width as the door and the free end of which is removeably attached to the floor adjacent the lower edge of the door. The roller screen has a driving spring which is wound up as the retractable door opens and the screen is drawn out and which acts to roll up the screen as the door is closed. The free end of the screen is attached to the floor adjacent the lower edge of the door by connectors which can be uncoupled to allow access. The screen can also be built into the lower edge of a retractable door and its vertical edges can be retained in the same track which guides the opening door.

### FIELD OF THE INVENTION

This invention relates to screen attachments for retractable doors such as those used in domestic garages

### BACKGROUND OF THE INVENTION

When garage doors are left open to improve ventilation, the open doorway allows the entry of insects and animals. A number of attempts have been made to overcome this problem.

For example in U.S. Pat. No. 6,705,378 a secondary retractable screen door is installed inside the primary garage door opening, and operates independently of the primary door. This obviously requires the provision of a second set of tracks and an independent retraction mechanism.

In U.S. Pat. No. 6,557,614 a garage door is provided with a lower screen panel, which is released to slide down to cover the opening created when the door is partially raised. However this requires independent manual operation and only provides a relatively small screened opening next to the garage floor.

Installation of the above and other prior art screens for garage door openings requires additional hardware. Further an independent operation after opening the door is required to deploy the screen and this is time consuming and tedious.

### OBJECT OF THE INVENTION

It is therefore an object of the present invention to provide a screen for attachment to a retractable door which minimizes additional hardware and automates the operation of the screen.

### STATEMENT OF THE INVENTION

According to the present invention a roller screen is attached to the lower edge of a retractable door, which screen is the same width as the door and the free end of which is removeably attached to the floor adjacent the lower edge of the door.

Preferably the roller screen has a driving spring which is wound up as the retractable door opens and the screen is drawn out and which acts to roll up the screen as the door is closed.

Preferably the free end of the roller screen is attached to the floor adjacent the lower edge of the door by connectors which can be uncoupled to allow access.

Preferably the free end of the screen has a metal strip which attaches to an electromagnetic strip recessed in the floor adjacent the lower edge of the door.

Preferably the electromagnetic strip can be energized by a remote controller which automates the opening of the doorway for vehicular access.

Preferably the roller screen is reinforced by edge strips and median strips to maintain its shape.

Preferably the roller screen has an opening panel to allow limited access.

Preferably the roller screen is housed in a protective casing.

In an alternative embodiment of the invention a roller screen is built into the lower edge of a retractable door, the free end of which screen is attached to the ground adjacent the lower edge of the door and the vertical edges of which are retained in the same track which guides the opening door.

### BRIEF DESCRIPTION OF THE DRAWINGS

An embodiment of the invention is now described by way of example only with reference to the accompanying drawings in which:

FIG. 1 is a side elevation of a partially open retractable door with the roller screen partially extended and

FIG. 2 is a front elevation with the retractable door fully open and the screen fully extended over the door opening.

### DETAILED DESCRIPTION OF THE INVENTION

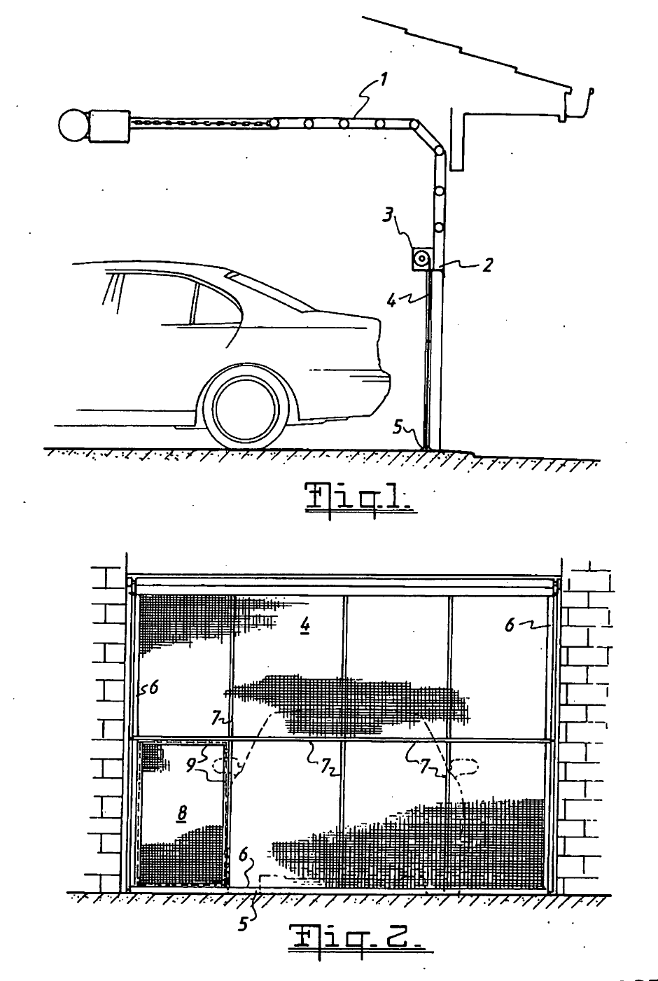

The retractable garage door 1 in FIG. 1 is partially opened and has attached to the rear of its lower edge 2 a case 3 containing a roller screen 4 having the same width as the door 1. The free end of the screen 5 is attached by hooks to eyes fixed in the garage floor where the edge of the door sits in its closed position.

As door 1 opens, screen 4 unrolls from a roller pivoted in the case and progressively closes off the garage doorway as door 1 retracts. Accordingly when door 1 is fully open, screen 4 closes off the entire garage doorway preventing access but providing ventilation. Screen 4 is reinforced with edge strips 6 around its perimeter and median strips 7 which assist the screen to maintain its extended shape closing off the doorway.

Metal hooks are located in the free end 5 of screen 4 to engage eyelets in the garage floor. Accordingly the screen can be unhooked from the eyelets allowing the screen to retract with the door when vehicle access to the garage is required. A panel 8 which can be opened by means of zips or Velcro strips 9 is built into the lower left corner of screen 4 thus providing limited access.

Alternative coupling means could be provided to restrain free end 5 of screen 4. For example, an electromagnetic strip could be provided in the garage floor to attract a metal bar built into the free end 5 of screen 4 and the strip could be magnetized and demagnetized by a remote controller thereby restraining or releasing the screen.

The above embodiment is adapted to be retrofitted to existing roller doors and requires no modification of the existing installation. However new retractable doors could be manufactured with roller screen 4 built into the lower edge of door 1. This embodiment could operate so that the outer vertical edges of the screen are retained by the door guide tracks thus providing additional support to the screen in the open position. The operation of an electromagnetic restraining strip as described above could also be built into the remote control mechanism of the door thus making the opening operation for vehicular access completely automatic.

### VARIATIONS

It will be realized that the foregoing has been given by way of illustrative example only and that all other modifications and variations as would be apparent to persons skilled in the art are deemed to fall within the broad scope and ambit of the invention as herein set forth. Throughout the description and claims of this specification the words “comprise” and variations of that word such as “comprises” and “comprising” are not intended to exclude other additives components integers or steps.

1. A roller screen attachment for the lower edge of a retractable door, which screen is the same width as the door and the free end of which is removeably attached to the floor adjacent the lower edge of the door.

2. The roller screen of claim 1 having a driving spring which is wound up as the retractable door opens and the screen is drawn out, and which acts to roll up the screen as the door is closed.

3. The roller screen of claim 1 wherein the free end of the screen has connectors which engage mating members recessed in the floor adjacent the lower edge of the door.

4. The roller screen of claim 1 wherein the free end of the screen has a metal strip which attaches to an electromagnetic strip recessed in the floor adjacent the lower edge of the door.

5. The roller screen of claim 4 wherein the electromagnetic strip can be energized by a remote controller which automates the opening of the doorway for vehicular access.

6. The roller screen of claim 1 which is reinforced with edge strips and median strips to maintain its shape.

7. The roller screen of claim 1 which has an opening panel to allow limited access.

8. A roller screen built into the length of the lower edge of a retractable door, the free end of which screen is removably attached to the ground adjacent the lower edge of the door and the vertical edges of which are retained in the same track which guides the opening door.
